(19) United States
(12) Patent Application Publication
(10) Pub. No.: US 2021/0276459 A1
(43) Pub. Date: Sep. 9, 2021

(54) SEATING SYSTEM AND METHOD

(71) Applicant: Lear Corporation, Southfield, MI (US)

(72) Inventor: Arjun Yetukuri, Rochester Hills, MI (US)

(21) Appl. No.: 16/809,125

(22) Filed: Mar. 4, 2020

(51) Int. Cl. B60N 2/02; B60N 2/00; B60N 2/56; B60N 2/90

(52) U.S. Cl. CPC B60N 2/0248; B60N 2/002; B60N 2002/0268; B60N 2/976; B60N 2/0232; B60N 2/5685

(57) ABSTRACT

A seating system includes a seat assembly, an electronic control unit (ECU), and an actuator connected to the seat. The ECU may be configured to obtain actuator information associated with operating the actuator. The ECU may be configured to associate the actuator information with a user profile of a user of the seat. A method of operating a seating system may include receiving, via a remote server, a ride request including a user profile, operating an actuator of a seat of the seating system, obtaining actuator information corresponding to the actuator of the seat, and/or associating the actuator information with the user profile.

### TECHNICAL FIELD

The present disclosure generally relates to seating systems, including seating systems that may, for example, be configured to monitor the use of seat actuators.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some seating systems may not be configured to monitor the use of actuator assemblies, some seating systems may not be configured to transmit actuator information, and/or some seating systems may be inefficient.

There is a desire for solutions/options that minimize or eliminate one or more challenges or shortcomings of seating systems. The foregoing discussion is intended only to illustrate examples of the present field and should not be taken as a disavowal of scope.

### SUMMARY

In embodiments, a seating system may include a seat assembly, an electronic control unit (ECU), and/or an actuator connected to a seat of the seat assembly. The ECU may be configured to obtain actuator information associated with operating the actuator. The ECU may be configured to associate the actuator information with a user profile of a user of the seat.

With embodiments, a method of operating a seating system may include receiving, via a remote server, a ride request including a user profile, operating an actuator of a seat of the seating system, obtaining actuator information corresponding to the actuator of the seat, and associating the actuator information with the user profile.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and are not restricted to the precise form and configuration shown in the drawings or disclosed in the following detailed description. Exemplary illustrations are described in detail by referring to the drawings as follows:

FIG. 1 is a side view generally illustrating portions of an embodiment of a seat of a seating system according to teachings of the present disclosure.

FIG. 2 is a top view generally illustrating portions of an embodiment of a seating system according to teachings of the present disclosure.

FIG. 3 is a schematic generally illustrating portions of an embodiment of a seating system according to teachings of the present disclosure.

FIG. 4 is a side view generally illustrating portions of an embodiment of a seating system according to teachings of the present disclosure.

FIG. 5 is a flowchart generally illustrating an embodiment of a method of operating a seating system according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

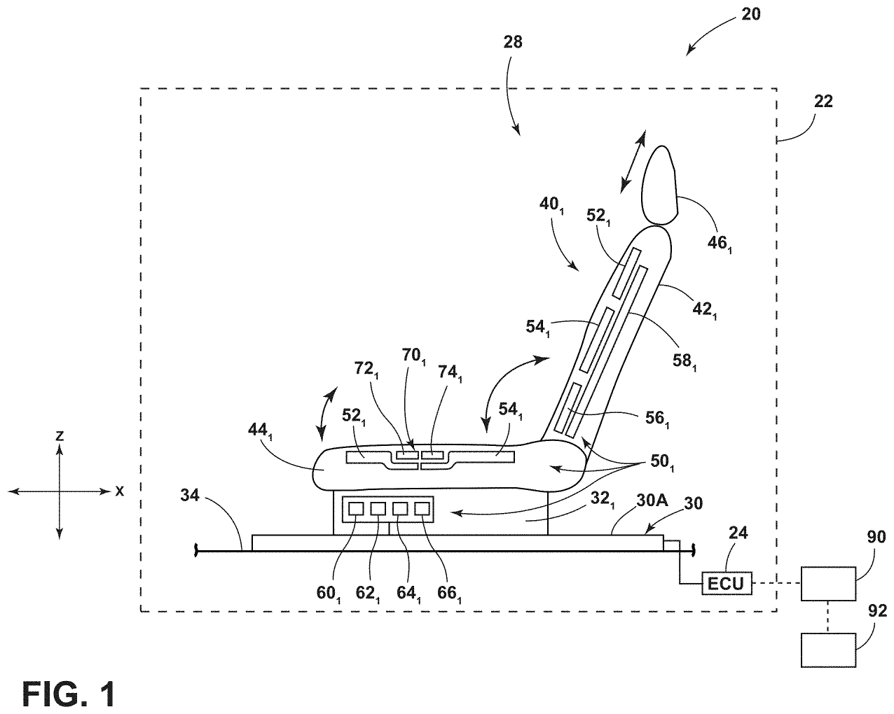

In embodiments, such as generally illustrated in FIG. 1, a seating system 20 may include a seat assembly 28 and/or an electronic control unit (ECU) 24 that may be connected (e.g., electrically) to the seat assembly 28. The seating system 20 may, for example and without limitation, be configured to be disposed within a vehicle 22 and/or other mode of transportation. The ECU 24 may be connected (e.g., wirelessly and/or via a wired connection) to the seat assembly 28 such that the ECU 24 may monitor activity/use of the seat assembly 28. The seat assembly 28 may include one or more seats 40_{N}, and/or the ECU 24 may be configured to monitor and/or sense activity/use of the one or more seats 40_{N}. The ECU 24 may be connected to a remote server 90, and/or the ECU 24 may be configured to communicate with (e.g., send information to and/or receive information from) the remote server 90. The ECU 24 may be configured to transmit information corresponding to seat activity/use to the remote server 90.

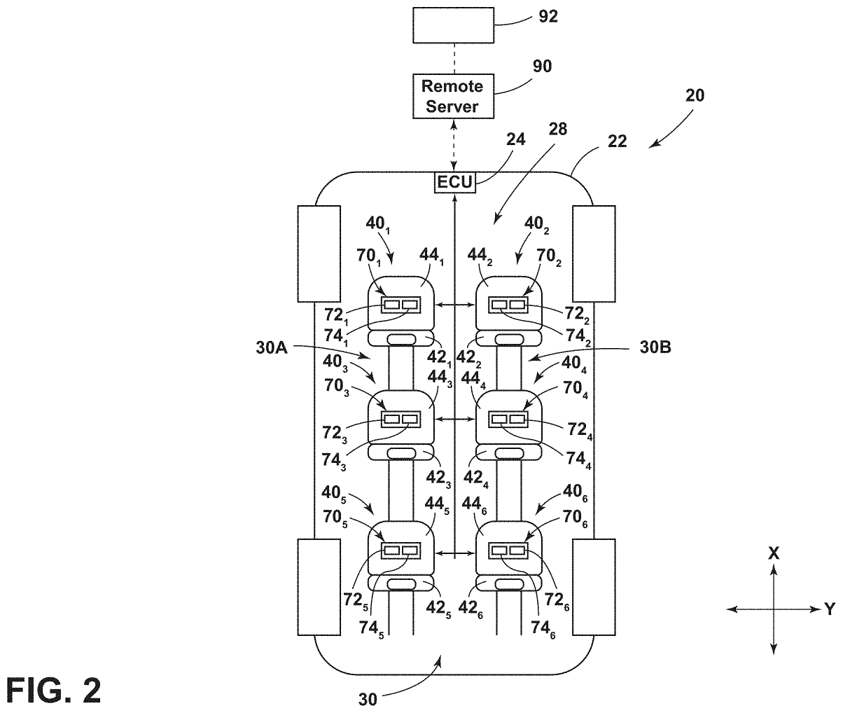

With embodiments, such as generally illustrated in FIGS. 1 and 2, a seating system 20 may include a seat assembly 28 and/or a track assembly 30. The seat assembly 28 may include a first seat 40₁, which may include a seat back 42₁, a seat base 44₁, and/or a head restraint 46₁. The seat back 42₁, the seat base 44₁, and/or the head restraint 46₁ may be configured to move, rotate, and/or pivot in one or more of a variety of directions. The first seat 40₁ may be connected to the track assembly 30 via a support member 32₁. The support member 32₁ may be selectively connected with the track assembly 30. For example and without limitation, the support member 32₁ may be configured to be inserted vertically and/or horizontally into the track assembly 30, such as in a plurality of locations along the track assembly 30. The support member 32₁ may be configured to be removed vertically and/or horizontally from the track assembly 30. The support member 32₁ may be configured to move along the track assembly 30 (e.g., in the X-direction).

In embodiments, such as generally illustrated in FIGS. 1 and 2, the track assembly 30 may be disposed on a mounting surface 34 (e.g., a vehicle floor). The track assembly 30 may extend substantially in the X-direction. The track assembly 30 may include a first track portion 30A and/or a second track portion 30B (see, e.g., FIG. 2). The first track portion 30A and/or the second track portion 30B may extend substantially parallel to each other. The seat assembly 28 may include a second seat 40₂, a third seat 40₃, a fourth seat 40₄, a fifth seat 40₅, and/or a sixth seat 40₆. The first seat 40₁, the second seat 40₂, the third seat 40₃, the fourth seat 40₄, the fifth seat 40₅, and/or the sixth seat 40₆ may be selectively connected to the first track portion 30A and/or the second track portion 30B. For example and without limitation, the first seat 40₁, the third seat 40₃, and/or the fifth seat 40₅ may be connected to the first track portion 30A. Additionally or alternatively, the second seat 40₂, the fourth seat 40₄, and/or the sixth seat 40₆ may be connected to the second track portion 30B. The second seat 40₂, the third seat 40₃, the fourth seat 40₄, the fifth seat 40₅, and/or the sixth seat 40₆ may include seat backs 42₂, 42₃, 42₄, 42₅, 42₆, seat bases 44₂, 44₃, 44₄, 44₅, 44₆ and/or head restraints 46₂, 46₃, 46₄, 46₅, 46₆, respectively, that may be configured to move, rotate, and/or pivot in one or more of a variety of directions. The seats 40₁, 40₂, 40₃, 40₄, 40₅, 40₆ may be connected with the track assembly 30 via respective support members 32₁, 32₂, 32₃, 32₄, 32₅, 32₆.

In embodiments, such as generally illustrated in FIG. 1, a first seat 40₁ of the seat assembly 28 may include a first actuator assembly 50₁ that may include one or more actuators. For example and without limitation, the actuators may include seat warmers 52₁, massagers 54₁ (e.g., air bladders, eccentric motors, etc.), adjustable lumbar supports 56₁, seat cooling modules 58₁, and/or seat position adjustment actuators 60₁, 62₁, 64₁, 66₁, among others. The seat position adjustment actuators 60₁, 62₁, 64₁, 66₁, which may include electric motors, may be configured to change seat back and/or seat base angle, height, and/or position, and may be configured to change a head restraint position. With embodiments, an actuator assembly 50₁ may include one or more actuators that may or may not move during actuation/activation. For example and without limitation, an actuator of an actuator assembly 50₁ may be a seat warmer/heater 52₁ that may not be configured to move. An actuator assembly 50_{N} (e.g., actuator assembly 50₁) may be configured to adjust a seat 40_{N} in any number of manners, such as to accommodate the preferences of a user occupying the respective seat 40_{N}. The actuators 52₁, 54₁, 56₁, 58₁, 60₁, 62₁, 64₁, 66₁ may be disposed in the seat back 42₁, the seat base 44₁, and/or the support member 32₁. The actuators 52₁, 54₁, 56₁, 58₁, 60₁, 62₁, 64₁, 66₁ may be controlled by a user that may be assigned to and/or may be occupying the first seat 40₁.

With embodiments, the second seat 40₂ may include a second actuator assembly 502, the third seat 40₃ may include a third actuator assembly 50₃, the fourth seat 40₄ may include a fourth actuator assembly 50₄, the fifth seat 40₅ may include a fifth actuator assembly 50₅, and/or the sixth seat 40₆ may include a sixth actuator assembly 506. The actuator assemblies 50_{N} may each include a different number of actuators (e.g., seat adjustment features). Additionally or alternatively, some or all of the actuator assemblies 50_{N} may be substantially similar, and/or may include the same number and/or type of actuators. The actuator assemblies 50_{N} may correspond with different levels of adjustability for the seats 40_{N} of the seat assembly 28. With embodiments, an actuator assembly 50_{N} may include a single actuator or a plurality of actuators.

With embodiments, such as generally illustrated in FIGS. 1 and 2, a seat assembly 28 may be electrically connected to the ECU 24. The seat assembly 28 may be configured to communicate with the ECU 24, and/or one or more seats 40_{N} may be configured to communicate with the ECU 24. For example and without limitation, the ECU 24 may receive information from some or all seats 40_{N} of the seat assembly 28, and/or the ECU 24 may receive information from the seat assembly 28 as a whole (e.g., if the seat assembly 28 includes an additional/separate control/communication unit). The seat assembly 28 and/or seats 40_{N} may be connected to the ECU 24 via a wireless and/or wired connection. The ECU 24 may be configured to communicate with the actuator assemblies 50_{N} of the seat assembly 28. For example and without limitation, the ECU 24 may monitor activity of the actuator assemblies 50_{N} and/or the ECU 24 may be configured to control operation of the actuator assemblies 50_{N}.

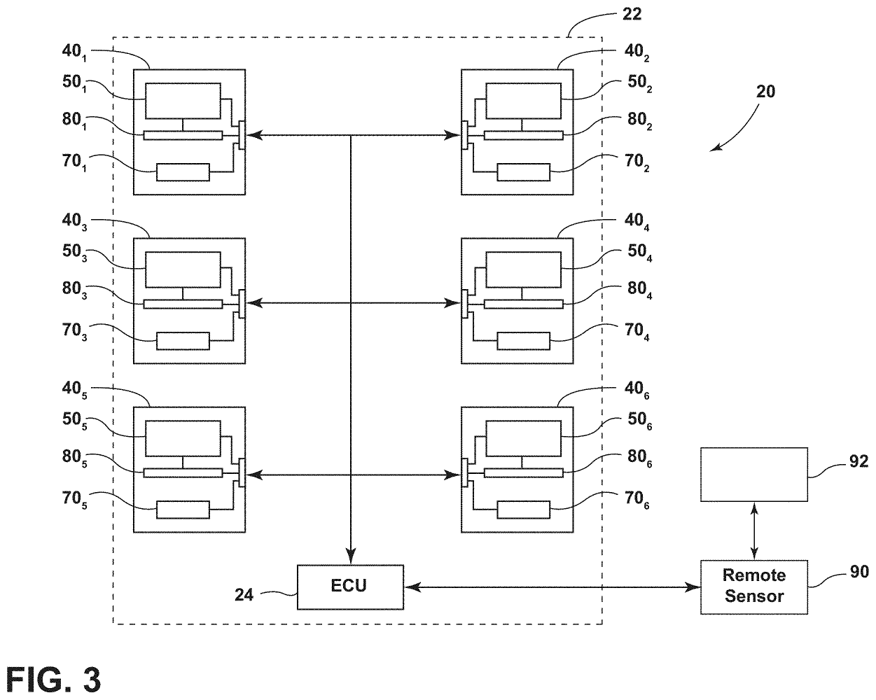

In embodiments, such as generally illustrated in FIGS. 1 and 3, the seat assembly 28 may include one or more occupancy sensors 70_{N} (e.g., sensors 70₁, 70₂, 70₃, 70₄, 70₅, 70₆). For example and without limitation, one or more seats 40_{N} of the seat assembly 28 may include and/or be associated with a respective occupancy sensor 70_{N}. A first occupancy sensor 70₁ may be connected to and/or disposed in the first seat 40₁, a second occupancy sensor 70₂ may be connected to and/or disposed in the second seat 40₂, a third occupancy sensor 70₃ may be connected to and/or disposed in the third seat 40₃, a fourth occupancy sensor 70₄ may be connected to and/or disposed in the fourth seat 40₄, a fifth occupancy sensor 70₅ may be connected to and/or disposed in the fifth seat 40₅, and/or a sixth occupancy sensor 70₆ may be connected to and/or disposed in the sixth seat 40₆. An occupancy sensor 70_{N} may, for example and without limitation, include a camera that may be associated with (e.g., directed at least partially at) a seat 40_{N}.

With embodiments, such as generally illustrated in FIGS. 1, 2, and 3, an occupancy sensor 70_{N} may include one or more biometric sensors 72_{N} (e.g., biometric sensors 72₁, 72₂, 72₃, 72₄, 72₅, 72₆) and/or weight/pressure sensors 74_{N} (e.g., weight/pressure sensors 74₁, 74₂, 74₃, 74₄, 74₅, 74₆). A biometric sensor 72_{N} and/or a weight/pressure sensor 74_{N} may be configured for determining whether a user is seated in a seat 40_{N} and/or to identify the user sitting in a seat 40_{N}. The biometric sensors 72_{N} may be configured to collect biometric/biomedical information (e.g., heart rate, breathing rate, blood pressure, etc.) from a user that may be in contact with/proximate a seat 40_{N} of the seat assembly 28. A biometric sensor 72_{N} may be disposed substantially proximate an outer surface of the seat back 42_{N} and/or the seat base 44_{N}. Disposing a biometric sensor 72_{N} proximate an outer surface may reduce the distance between the biometric sensor 72_{N} and a user, which may increase the accuracy of collected biometric/biomedical information. The occupancy sensor(s) 70_{N} may be electrically connected with the ECU 24 such that the ECU 24 may communicate (e.g., wired and/or wirelessly) with the occupancy sensor(s) 70_{N}. The occupancy sensor(s) 70_{N} may, for example and without limitation, be configured to transmit occupant information (e.g., biometric information from one or more biometric sensors 72_{N}) to the ECU 24, and/or the ECU 24 may be configured to receive occupant information from the occupancy sensors 70_{N}.

In embodiments, such as generally illustrated in FIG. 3, the seat assembly 28 may include one or more actuator sensors 80_{N} (e.g., actuator sensors 80₁, 80₂, 80₃, 80₄, 80₅, 80₆). For example and without limitation, the first seat 40₁ may include and/or be associated with a first actuator sensor 80₁, the second seat 40₂ may include and/or be associated with a second actuator sensor 80₂, the third seat 40₃ may include and/or be associated with a third actuator sensor 80₃, the fourth seat 40₄ may include and/or be associated with a fourth actuator sensor 80₄, the fifth seat 40₅ may include and/or be associated with a fifth actuator sensor 80₅, and/or the sixth seat 40₆ may include and/or be associated with a sixth actuator sensor 80₆. The actuator sensors 80_{N} may be electrically connected (e.g., wired and/or wirelessly) with respective actuator assemblies 50_{N}. The actuator sensors 80_{N} may, for example and without limitation, be configured to monitor the use/activity of the actuator assemblies 50_{N}, respectively.

With embodiments, the actuator sensors 80_{N} may be configured to obtain/collect actuator information. Actuator information may correspond to the use/activity of the actuator assemblies 50_{N}. Actuator information may include (i) duration information, (ii) actuator-type information, and/or (iii) consumption information, among others. For example and without limitation, duration information may correspond to the amount of time each actuator of the actuator assemblies 50_{N} has been activated. Actuator-type information may identify a particular type of actuator of the actuator assemblies 50_{N} activated by a user while occupying the respective seat 40_{N}. Consumption information may correspond to the amount of energy/power consumed by operation of the actuator assemblies 50_{N}. The consumption information may indicate the energy consumption of each actuator 52₁, 54₁, 56₁, 58₁, 60₁, 62₁, 64₁, 66₁ and/or the actuator assembly 50_{N} as a whole. The ECU 24 may be configured to obtain the actuator information (e.g., duration information, actuator-type information, consumption information, etc.) from the actuator sensors 80_{N}. The ECU 24 may, for example, be configured to analyze, use, store, and/or transmit said information.

In embodiments, such as generally illustrated in FIGS. 2 and 3, the ECU 24 may be connected to a remote server 90. The ECU 24 may communicate with the remote server 90 (e.g., the ECU 24 may transmit information to and/or receive information from the remote server 90). The remote server 90 may be configured to connect to one or more additional servers, and/or may be configured to communicate with one or more mobile electronic devices 92 (e.g., smartphones, tablets, laptops, etc.). The remote server 90 may be configured to store information (e.g., in a data cloud, physical storage medium, blockchain, etc.), and/or may be configured to read and write information to and from a variety of data storage locations. The remote server 90 may be configured to receive a ride request from a user. The ride request may include one or more of a variety of types of information. For example and without limitation, the ride request information may include a user profile, current position, destination, route, seat assignment, and/or seat level information. The remote server 90 and/or the ECU 24 may determine a seat assignment for a user in a respective vehicle 22 based on the ride request information. The remote server 90 and/or the ECU 24 may transmit seat assignment information to the user (e.g., to a mobile electronic device 92 associated with the user) and/or indicate the seat assignment information within the user profile.

With embodiments, the user profile may indicate various types of identifying and/or seat setting information. For example and without limitation, seat setting information may include temperature preferences, massage function preferences, seat warmer preferences, ventilated seat preferences, etc. Additionally or alternatively, the user profile may include biometric data (e.g., heart rate, weight, blood pressure, etc.) corresponding to a specific user. The ECU 24 may use the user profile and/or the biometric sensors 72_{N} to verify that a user is seated in a respective assigned seat 40_{N} according to the seat assignment information. For example and without limitation, the ECU 24 may compare the biometric information of the user profile with the measured biometric information via the biometric sensors 72_{N} to confirm the user is occupying the assigned seat 40_{N}. The ECU 24 may be configured to alert the user (e.g., via audible alert, visual alert, haptic alert, etc.) if the user is not seated in the assigned seat 40_{N}.

In embodiments, the user profile may be stored on the ECU 24, the remote server 90, and/or a mobile electronic device 92 that may be associated with a user. For example and without limitation, the user profile may be at least temporarily loaded to the ECU 24 (e.g., from the remote server 90) while the user is assigned to a seat 40_{N} of the vehicle 22. The ECU 24 may delete the user profile and/or transmit the user profile back to the remote server 90 and/or the mobile electronic device 92 of the user upon the conclusion of a trip. The ECU 24 may be configured to read from and/or write to the user profile while the user is occupying the assigned seat 40_{N}. The ECU 24 may be configured to write/save actuator information, such as (i) duration information, (ii) actuator-type information, and/or (iii) consumption information, to the user profile.

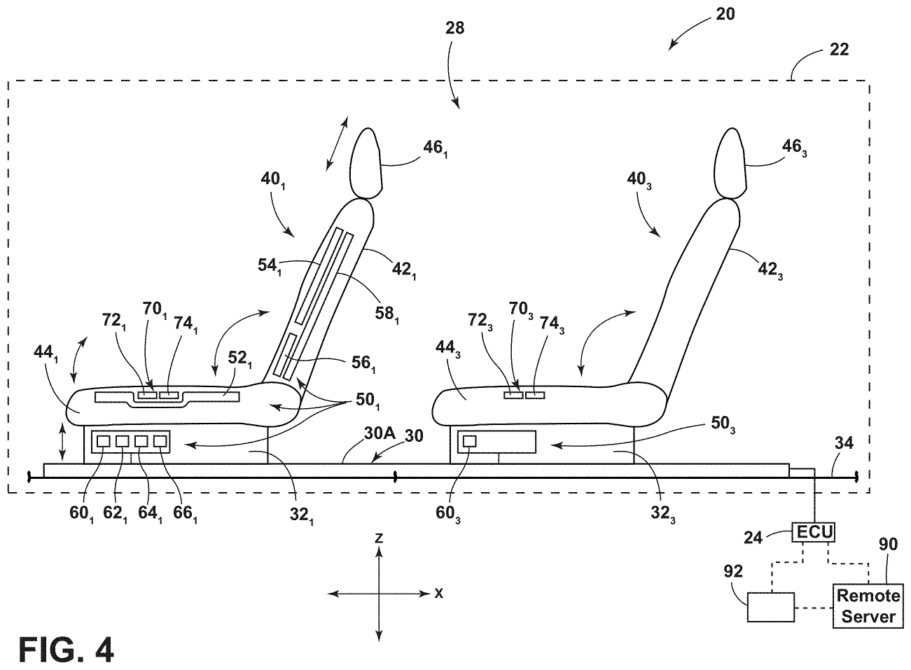

With embodiments, the ride request may include an indication of whether the user prefers one or more of a variety of levels of seat preferences. For example and without limitation, the levels of seat preferences may correspond to a one or more of a variety of potential seat adjustments that may be provided via actuator assemblies SO_{N} that may be associated with the seats 40_{N}. In embodiments, such as generally illustrated in FIG. 4, the seats 40_{N} of a seat assembly 28 may include a first level of seat preference (see, e.g., seat 40₁) and/or a second level of seat preference (see, e.g., seat 40₃), but seats 40_{N} are not limited to two levels. The first level of seat preference may correspond to a first seat configuration and/or the second level of seat preference may correspond to a second seat configuration. Seats 40_{N} of the seat assembly 28 that have the first configuration may include more actuators than seats 40_{N} of the seat assembly 28 including the second configuration. For example and without limitation, seats 40_{N} having the first configuration may be adjusted to a greater degree than seats 40_{N} having the second configuration.

In embodiments, such as generally illustrated in FIG. 4, the first seat 40₁ may include the first seat configuration corresponding to the first level of seat preference, and/or the third seat 40₃ may include the second seat configuration corresponding to the second level of seat preference. The first seat 40₁ may include a seat warmer 52₁, a massager 54₁, an adjustable lumbar support 56₁, a seat cooling module 58₁, seat position adjustment actuators 60₁, 62₁, 64₁, 66₁, and/or an occupancy sensor 70₁, among others. The third seat 40₃ (e.g., having the second configuration) may include a seat position adjustment actuator 603 and/or an occupancy sensor 70₃, and may, for example, not include some actuators of the first seat 40₁, such as a seat cooling module, lumbar support, and/or other actuators.

With embodiments, before assigning a seat 40_{N} to a user, the remote server 90 and/or the ECU 24 may be configured to suggest a recommended seat level to the user, such as based on the projected travel time/distance of the driving route of a user. For example and without limitation, if a destination is a long distance (e.g., about 10 miles or more) from the pickup location of the user (e.g., the user is expected to occupy a seat 40_{N} for an extended period of time), the ECU 24 and/or remote server 90 may provide the user with a recommendation to select a seat 40_{N} including the first level of seat preference (e.g., seat 40₁). If a destination is a short distance away (e.g., about 10 miles or less) from the pickup location of the user (e.g., the user is expected to occupy a seat 40_{N} for a relatively short period of time), the ECU 24 and/or remote server 90 may provide the user with a recommendation to select a seat 40_{N} including the second level of seat preference (e.g., seat 40₃). In some circumstances, the ECU 24 may recommend a seat 40_{N} including the first level of seat preference even with short distances (e.g., if the user has a painful condition, if the user requires the first level of seat preference, etc.). The ECU 24 and/or remote server 90 may be configured to collect history information corresponding to the past trips of a user. The history information may indicate the levels of seat preferences a user selects when occupying a vehicle 22 for a variety of durations. The ECU 24 and/or the remote server 90 may provide the user with a suggested seat level preference according to the history information of the user. For example and without limitation, if the user has only selected first level seats, regardless of travel distance, the ECU 24 and/or the remote server 90 may provide the user with a recommendation for a first level seat and/or may automatically assign, at least initially, a first level seat to the user.

With embodiments, the ECU 24 may be configured to communicate (e.g., directly and/or indirectly) with the mobile electronic device 92 of a user. If the mobile electronic device 92 is substantially proximate a seat 40_{N} of the seat assembly 28, the ECU 24 may be configured to identify the user, via the mobile electronic device 92, that is occupying the seat 40_{N}. The ECU 24 may be configured to obtain actuator information (e.g., monitor duration information, actuator-type information, consumption information, etc.) for the respective seat 40_{N} and user, and/or the ECU 24 may be configured to provide said actuator information to the remote server 90 and/or the mobile electronic device 92 of the user. The mobile electronic device 92 of the user may be configured to communicate with the remote server 90.

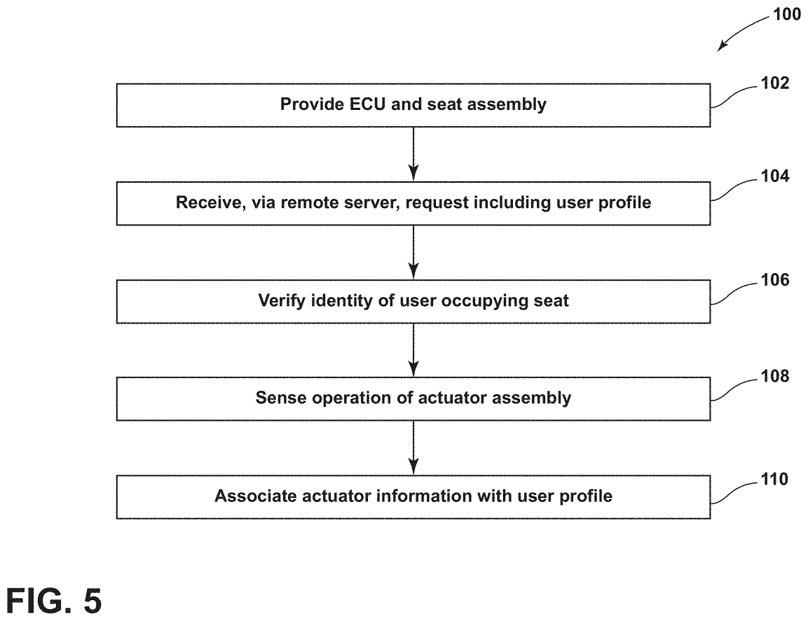

In embodiments, such as generally illustrated in FIG. 5, a method 100 of operating a seating system 20 may include providing a seat assembly 28 and/or an ECU 24 (step 102). The ECU 24 may be connected with the seat assembly 28 and/or may be configured to monitor adjustments of the 40_{N} seats of the seat assembly 28. The ECU 24 may be connected to a remote server 90 such that the ECU 24 and/or the remote server 90 may communicate/share seat profile information and/or seat use/activity information. The method 100 may include the ECU 24 receiving a ride request (e.g., via the remote server 90 and/or a mobile electronic device 92) (step 104). The ECU 24 may process/analyze information contained within the ride request (e.g., such as current position, destination, route, user profile, seat assignment, seat level information, etc.). The method 100 may include verifying the identity of a user upon the user occupying a seat 40_{N} of the seat assembly 28 (step 106). For example and without limitation, the ECU 24 may confirm whether the user is seated in a seat 40_{N} including the correct seat level (e.g., a seat 40_{N} having a corresponding seat configuration as desired by the user) as indicated by user profile/remote server 90. The method 100 may include the ECU 24 receiving biometric information from an occupancy sensor 70_{N} and/or the ECU 24 receiving biometric information from the remote server 90, such that the ECU 24 may verify (e.g., by comparing/analyzing) whether the respective user is seated in the assigned seat 40_{N}.

With embodiments, the method 100 of operating the seating system 20 may include the ECU 24 obtaining actuator information of the actuator assemblies SO_{N}, such as via one or more actuator sensors 80_{N} (step 108). Actuator information may, for example and without limitation, include duration information, actuator-type information, and/or consumption information. The method 100 may include the ECU 24 associating the actuator information with the user profile (step 110). Additionally or alternatively, the method 100 may include transmitting the actuator information and/or an updated user profile to the remote server 90 and/or the mobile electronic device 92. For example and without limitation, the ECU 24 may receive the user profile, and/or the ECU 24 may save actuator information to the corresponding user profile. The ECU 24 may be configured to transmit the user profile to the remote server 90, and/or the ECU 24 (and/or the remote server 90) may update the user profile on the remote server 90.

In embodiments, associating actuator information with a user profile (e.g., step 110) may include determining an amount owed by the user and/or generating a bill according to the actuator information for the user. The amount owed may, for example, reflect costs/charges associated with the duration of use of the actuator assembly SO_{N} (duration information), costs/charges associated with the specific type of actuator activated (actuator-type information), and/or costs/charges associated with the energy consumption of the actuator assembly SO_{N} (consumption information). The ECU 24 and/or the remote server 90 may generate the bill. The ECU 24 and/or the remote server 90 may upload the bill to a corresponding user profile and/or the bill may be transmitted to a mobile electronic device 92 of the user via which the user may pay the bill. In embodiments, the ECU 24 and/or the remote server 90 may be configured to estimate the costs/charges associated with a particular seat 40_{N} and/or the actuator assembly SO_{N} thereof for the distance of travel (e.g., based on the request). The estimate may be provided to the mobile electronic device 92 associated with the user prior to the user occupying the seat 40_{N} and/or the ECU 24/remote server 90 may charge the user for the estimated amount (or place a hold for the estimated amount) prior to the user occupying the seat 40_{N}. While some embodiments of the method 100 may involve a mobile electronic device 92 associated with the user, other embodiments may be conducted independently of such a mobile electronic device 92.

In embodiments, an ECU (e.g., ECU 24) and/or a server (e.g., remote server 90) may include an electronic controller and/or include an electronic processor, such as a programmable microprocessor and/or microcontroller. In embodiments, an ECU/server may include, for example, an application specific integrated circuit (ASIC). An ECU/server may include a central processing unit (CPU), a memory (e.g., a non-transitory computer-readable storage medium), and/or an input/output (I/O) interface. An ECU/server may be configured to perform various functions, including those described in greater detail herein, with appropriate programming instructions and/or code embodied in software, hardware, and/or other medium. In embodiments, an ECU/server may include a plurality of controllers. In embodiments, an ECU/server may be connected to a display, such as a touchscreen display.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

It should be understood that an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A seating system, comprising:
a seat assembly including a seat;
an electronic control unit (ECU); and
an actuator connected to the seat;
wherein the ECU is configured to obtain actuator information associated with operating the actuator; and
the ECU is configured to associate the actuator information with a user profile of a user of the seat.

2. The seating system of claim 1, wherein the actuator information includes a duration of use of the actuator.

3. The seating system of claim 1, wherein the actuator information includes a type of the actuator.

4. The seating system of claim 1, wherein the actuator information includes consumption information corresponding to an amount of energy consumed by the actuator operated by the user.

5. The seating system of claim 1, wherein the ECU is configured to receive seat assignment information from a remote server;
the seat assignment information includes an assigned seat for the user; and
the ECU is configured to determine whether the user is occupying the assigned seat via an occupancy sensor.

6. The seating system of claim 5, wherein the occupancy sensor includes a biometric sensor.

7. The seating system of claim 1, wherein the actuator includes at least one of a heater, a massager, and/or a seat position adjustment motor.

8. The seating system of claim 1, wherein associating the actuator information with the user profile includes transmitting the actuator information to a remote server; and
at least one of the ECU and said remote server is configured to allocate charges corresponding to the actuator information to the user profile.

9. A seating system, comprising:
a seat assembly including a first seat and a second seat; and
an ECU connected to the seat assembly;
wherein the first seat corresponds to a first level of seat preference and the second seat corresponds to a second level of seat preference;
the first seat includes a first actuator assembly;
the second seat includes a second actuator assembly;
the first actuator assembly includes more actuators than the second actuator assembly;
the ECU is configured to obtain a request from a remote server;
the request includes a user profile; and
the ECU is configured to obtain actuator information associated with operation of at least one of the first actuator assembly and the second actuator assembly, and associate the actuator information with the user profile.

10. The seating system of claim 9, wherein the user profile includes seat level preference information indicating a preference between the first level of seat preference and the second level of seat preference.

11. The seating system of claim 10, wherein at least one of the ECU and the remote server is configured to assign a user to the first seat or the second seat according to the seat level preference information.

12. The seating system of claim 9, including:
a first occupancy sensor associated with the first seat; and
a second occupancy sensor associated with the second seat;
wherein the request indicates an assigned seat for a user; and
the ECU is configured to determine whether the user is occupying the assigned seat via at least one of the first occupancy sensor and the second occupancy sensor.

13. The seating system of claim 12, wherein the first occupancy sensor includes a first biometric sensor;
the second occupancy sensor includes a second biometric sensor; and
the first biometric sensor and the second biometric sensor are configured to sense biometric information of users occupying the first seat and the second seat, respectively.

14. The seating system of claim 9, wherein the actuator information includes at least one of duration information, actuator-type information, and consumption information.

15. The seating system of claim 14, wherein the ECU is configured to transmit the actuator information to the remote server.

16. A method of operating a seating system, the method comprising:
receiving a ride request via a remote server, the ride request including a user profile;
operating an actuator of a seat of the seating system;
obtaining actuator information corresponding to the actuator of the seat; and
associating the actuator information with the user profile.

17. The method of claim 16, wherein obtaining the actuator information includes obtaining at least one of duration information, actuator-type information, and consumption information associated with the actuator.

18. The method of claim 16, wherein associating the actuator information with the user profile includes transmitting the actuator information to the remote server and the remote server allocating charges corresponding to the actuator information to the user profile.

19. The method of claim 16, including providing a seat level suggestion to a user via a mobile electronic device of the user according, at least in part, to information from the user profile.

20. The method of claim 16, including determining, via an electronic control unit of the seating system, whether a user associated with the user profile is occupying the seat.
